(19) United States
(12) Patent Application Publication
(10) Pub. No.: US 2010/0174627 A1
(43) Pub. Date: Jul. 8, 2010

(54) System and Method to Analyze a Billing System Database and Revenue Performance by Applying Scientifically Proven Statistical Filters to Analyze Variation and Identify Useful Exceptions

(75) Inventor: Mark S. Daniels, San Diego, CA (US)

Correspondence Address: PROCOPIO, CORY, HARGREAVES & SAVITCH LLP, 525 B STREET, SUITE 2200, SAN DIEGO, CA, 92101, US

(73) Assignee: AUDIT QUALITY, INC., San Diego, CA (US)

(21) Appl. No.: 12/497,453

(22) Filed: Jul. 2, 2009

Related U.S. Application Data
(60) Provisional application No. 61/091,688, filed on Aug. 25, 2008.

(51) Int. Cl. G06Q 10/00; G06T 11/20; G06Q 50/00

(52) U.S. Cl. 705/30; 345/440

(57) ABSTRACT

Described herein are systems and methods for obtaining information and evaluating billing system process data to predict where problems occur. The systems and methods may be used to evaluate data collected over time by individual clients and their billing service providers. The systems and methods provide the ability to monitor any billing process and predict where problems and opportunities are in precise ways utilizing statistical rules and theories as well as control charts to analyze the existing billing data for clients to produce charts that reveal desired information, alerting the user to any exceptions, variations or abnormalities in the data as an exception report. Exceptions identified are presented in a summary file or other format allowing the user to quickly expose significant variation and assess the need for corrective action.

This application claims the priority of U.S. Provisional Application No. 61/091,688 filed Aug. 25, 2008, which is incorporated herein by reference in its entirety.

### FIELD OF THE INVENTION

The present invention generally relates to the field of obtaining, analyzing and evaluating information from a billing system process and predicting, identifying and clarifying causes of variation using both variable and attribute data.

### SUMMARY OF THE INVENTION

This invention discloses systems and methods for obtaining information and evaluating billing system process data to predict where problems occur. It is used to evaluate data collected over time by individual clients and their billing service providers. It provides the ability to monitor any billing process and predict where problems and opportunities are in precise ways that are only possible with this system and method. This system utilizes statistical rules and theories as well as control charts to analyze the existing billing data for clients to produce charts that reveal desired information, alerting the user to any exceptions, variations or abnormalities in the data as an exception report. Exceptions identified are presented in a summary file or other format allowing the user to quickly expose significant variation and assess the need for corrective action. It automates the analysis process and replaces manual examination of excessive and overwhelming amounts of data. This system solves problems that confront all users of billing system data including, but not limited to, time available for review, the value of personal time required to manage and control a business, relating large amounts of current data to larger amounts of historical data, recognizing what is important as a statistical, scientific fact rather than acting on subjective decision making. Clients of this system may include, but are not limited to, health care providers, hospitals, billing companies, practice managers, auditors, and consultants and subscribing facilities.

This system allows for a more efficient and routine use of statistical analysis in assessing data and improving the billing process, quality and revenue outcomes. It can accept data (including both variable and attribute data) from any billing information system. Data are loaded or imported into the system's database through files extracted by the client or client billing service provider. If system processing occurs at the client location, the client can extract the data and run the reports. The loaded/imported data from these billing systems are stored and accumulated in the database. The system can look at various parameters of the data including, but not limited to, modality, provider and practice identification numbers and other provider detail, site/service location name, point of service, insurance and/or patient type, attending doctor name, referring doctor name, date of service, procedural codes (CPT), quantity (CPT count), charge amount, payment amount (primary insurance, secondary insurance or personal payments), adjustment and/or write-off amount and description, charge entry date, payment entry date, adjustments and/or write-off entry date, time, counts, errors, first-pass pay rate, denial rate, percent of accounts receivable beyond 60, 90 and 120 days. The system can also look at formulas involving combinations of datasets including, but not limited to, net collection ratio and gross collection ratio, average charges and payments, and relative value units (RVU). For example, if charges are down at a specific site and there are statistical exceptions, the system will identify those exceptions and alert the client within an exception report.

This system and method may function as a module (running in one or more locations) in conjunction with one or more databases. The module can be installed on one or more central computers or can also function over a network. Reports can be accessed securely by the clients over the network which could be the Internet. The module can be made available for clients to access at locations of their choosing. Reports can also be provided to them on a secured, regular basis or on demand through requests.

The network can be a personal area network (“PAN”), a local area network (“LAN”), a wide area network (“WAN”), or a distributed combination of networks collectively comprising a global communications network such as the Internet. Billing companies may have the system installed on their IS systems and run their own reports. There is a requirement for Internet access to enable remote access to electronic reports. The network can be fixed in location, mobile, or may comprise a combination of fixed and mobile components. Additionally, the network may carry communications corresponding to a single network protocol or to multiple network protocols. For example, the network may be a UWB network for carrying high bandwidth wireless traffic. The data from the various clients are stored on one or more databases which can be accessed by the system. The database is continually or periodically updated with data. The system can be programmed to analyze the updated data and generate charts on clients' request. The statistical functionality of the module allows tens of thousands of billing data elements to be compared and for the relationship between them to be empirically analyzed.

This system enables the module user to receive and analyze massive datasets for reporting which then enables the client to quickly and easily understand their revenue processes, make meaningful predictions regarding their billing and collection processes and save significant time, money and labor. It enables billing company clients and other clients to internally manage variations and exceptions on a daily, weekly or monthly basis while allowing clients to quickly and easily achieve an understanding of their practice with monthly reporting which is currently impossible. Clients that change billing service providers are able use this system to bridge the information from both providers to achieve an integrated view of revenue performance over time. This can prevent large disruptions of cash flow common when changing billing service providers. Medical practices or other facilities that utilize billing will be able to know instantly where they are losing or gaining business, to assess the stability of their revenue data and to understand whether there are problems that require attention. The analysis generates reports including tables and control charts with hyperlinks and/or bookmarks that allows for easy page navigation. The reports can be displayed to the client or others through their computers or can be generated in hard copy. The reports can be generated in many formats a few of which are PDF, html, Crystal Reports, Excel and Word.

### BRIEF DESCRIPTION OF THE DRAWINGS

The details of the present invention, both as to its structure and operation, may be understood in part by study of the accompanying drawings, in which like reference numerals refer to like parts, and in which:

FIG. 1 is a high level diagram of one embodiment of the system and method;

FIG. 2A is a high level diagram of an embodiment of the system with a remote service set-up;

FIG. 2B is a high level diagram of an embodiment of the system with a local set-up;

FIG. 3 is an example of how data are processed in the system;

FIG. 4 is an example database diagram or schema illustrating example data which may be included in the system;

FIG. 5 is a flow diagram illustrating an example of how a new dataset is created

FIG. 6 is an example of a client report showing the exceptions for requested data types;

FIG. 7 are example graphs generated by the system of billing trends.

### DESCRIPTION OF EMBODIMENT OF INVENTION

After reading this description, the implementation of the invention in various embodiments and alternative applications will become apparent to one skilled in the art. Various embodiments of the present invention will be described herein; however, it is understood that these embodiments are presented as examples only. As such, this detailed description of various alternative embodiments should not be construed to limit the scope or breadth of the present invention as set forth below.

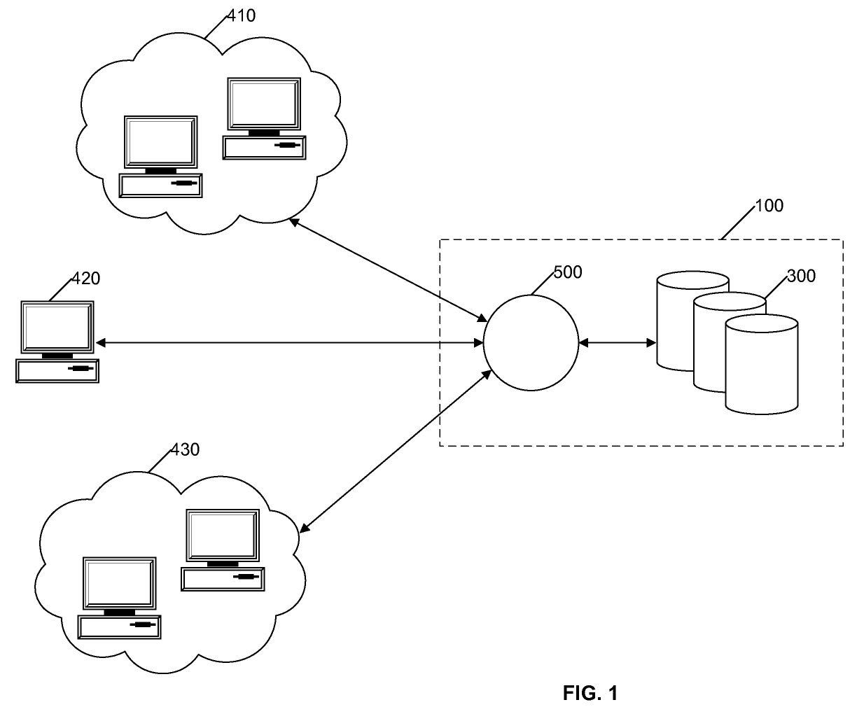

FIG. 1 is a high level diagram of one embodiment of the system and method. The system 100 includes the module 500 and one or more databases 300 which function in conjunction with one or more clients 410, 420 and 430. In this embodiment the module 500 is shown operating in a remote location with the database 300. Client computers 410, 420 and 430 are installed with “client” modules that send data and/or report requests to the module 500 via a wide area network server. The module 500 processes and sends reports back to the client computers. The client computers 410, 420 and 430 can be in a local area network or stand alone.

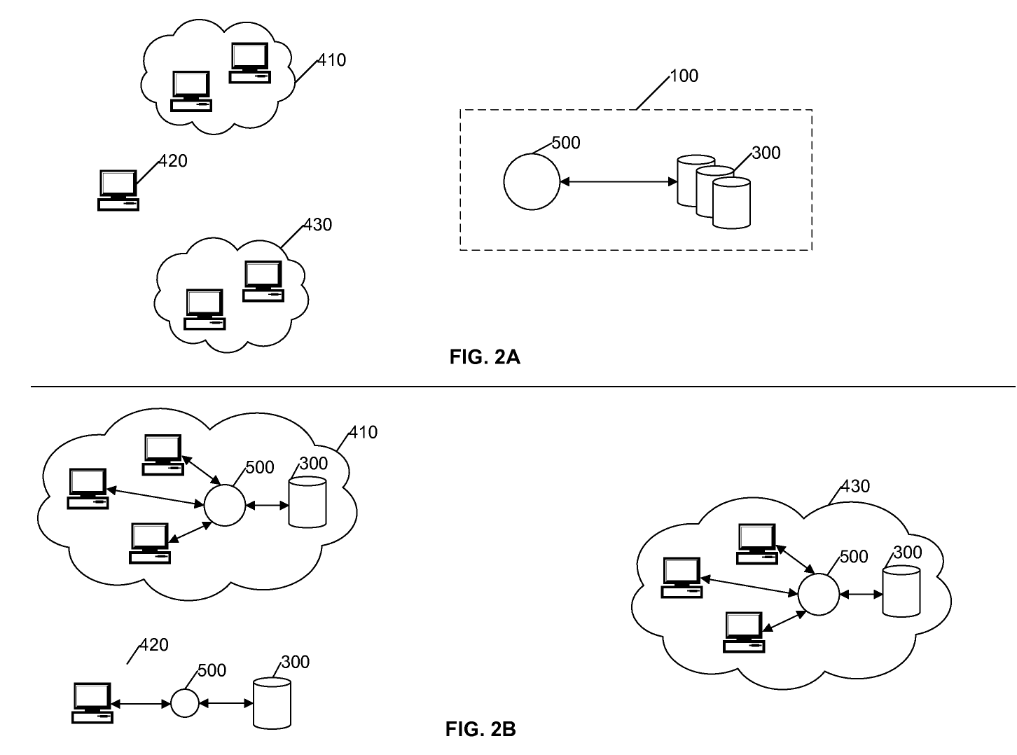

Referring to FIG. 2A an embodiment of the system 100 functioning with a remote service set-up is shown. In this embodiment a single module 500 is operated in a remote location along with the database 300. Client computers 410, 420, and 430 do not have a connection to the system 100. Reports are processed remotely and sent to clients through email, ground mail, fax or internet. The reports can sent in formats which include but are not limited to PDF, html, Crystal Reports, Excel and Word.

Referring to FIG. 2B an embodiment of the system 100 with a local set-up is shown. In this embodiment each client 410, 420, and 430 has a copy of the module which is operated either locally in the client's network 410 and 430 or in a stand-alone computer 420.

The network can be a personal area network (“PAN”), a local area network (“LAN”), or a wide area network (“WAN”). Network can be fixed in location, mobile, or may comprise a combination of fixed and mobile components. In one embodiment the network can be the Internet. The module 500 communicates with clients 410, 420 and 430, via a network such as the Internet. As an example, the clients 410, 420 and 430 are shown, however, it should be known that there can be any number of facilities, users and customers on the system. The module 500 can alternately be installed directly on the user or the client's computers.

The module 500 has direct access to one or more databases 300, which in one embodiment can utilize an SQL server. All client data are stored on one or more common SQL (or similar) server databases 300. There will be no remote access by clients to system data. The database 300 can be continually updated with new data from the clients 410, 420 and 430.

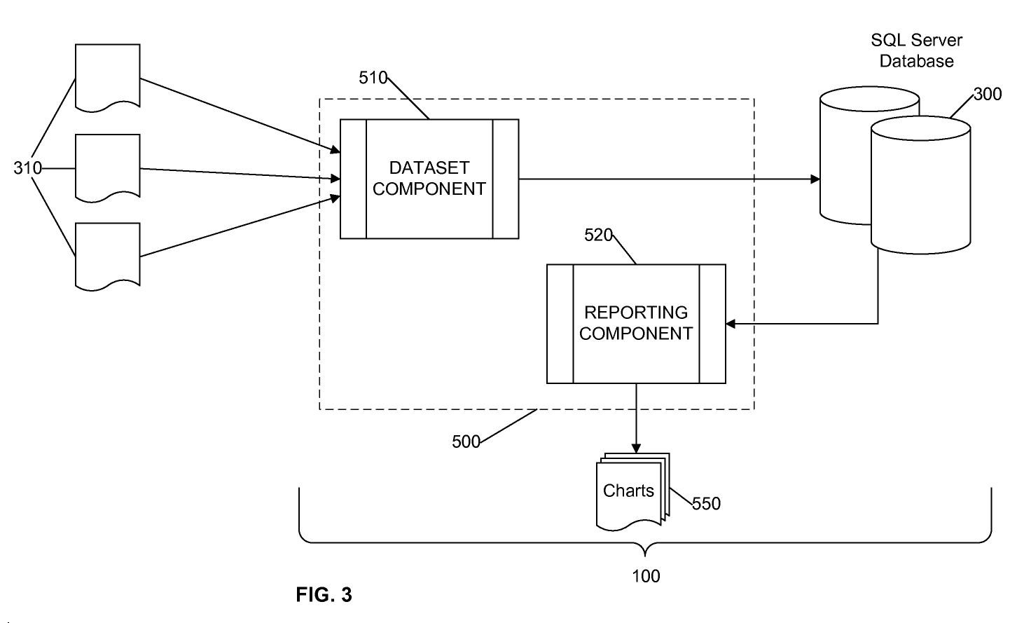

The database 300 handles the data management and data import functions of the system 100. The database 300 can accept uploaded data in the forms including, but not limited to, text files and delimited files. Data can be viewed but not downloaded from the system database. During the importation process, the database 300 examines the files to ensure that they meet the format requirements and that they contain all the columns necessary to populate the data fields of the target dataset. The database 300 also determines any duplication of data or errors in the data being imported and performs fixes or otherwise prompts the user for an action. The database 300 handles the maintenance of each existing client's dataset, as will be explained in FIG. 3 below. Each client may enter or define its own dataset creation requirements, which may include, for example, requesting the system to purge old data, combining new data with old and adding new data fields for analysis. The creator or an authorized user can also manage the client's dataset manually through the system 100.

FIG. 3 is an example of how data are processed in the system 100. Data 310 in the form of a flat file extract is imported into the module 500. Each client may supply data in a format proprietary to their billing system. The data contents of the flat file, therefore, can be in any format, but the most common formats are character delimited, fixed column and fixed width text. The import process “parses” the flat file based on data field mappings specially formulated for each client during dataset setup. This process analyzes the file syntactically and breaks it down into meaningful chunks of text to allow for extraction of data. These data go directly into the dataset component 510 of the module 500. To help in accurate extraction of data from the flat file, the client may supply a document that describes how the data is organized in the file. The client may also include column headings in the flat file itself that identifies the type of data in each column. The dataset component 510 handles the dataset management and data import functions of the module 500. During the import process, the dataset component 510 examines the text files to ensure that they meet the format requirements set up for the client and that they contain all columns necessary to populate the data fields of the target dataset.

The dataset component 510 also determines whether there are any duplication or errors in the data being imported and performs fixes or otherwise prompts the user for an action. Once the dataset component 510 of the module 500 has processed data 310, it passes it onto the database server 300 where these data are stored for future use. When either the client or other user prompts the module 500 for a report or a report is automatically requested, the reporting component 520 of the module 500 retrieves the data 310 from the database 300. The reporting component 520 of the module analyzes and processes the data as will be explained in more detail below. Once the data are processed and analyzed, the module 500 generates charts, graphs or other reports 550. These charts, graphs or other reports 550 are then provided to the client either by way of hard copy or the module generates the report with hyperlinks which is provided to the client by electronic file such as a Portable Document File (PDF) or other electronic format.

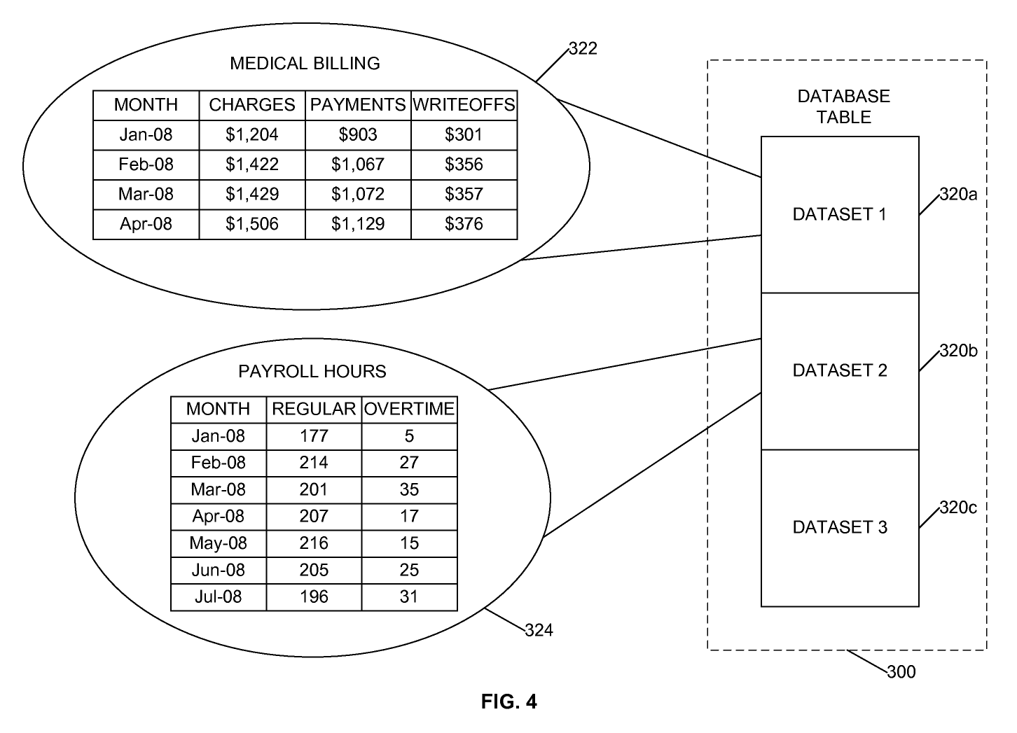

FIG. 4 is an example of a database diagram or scheme illustrating how datasets are included in the system. Once the data of FIG. 3 (310) is received by the module 500, it is organized in the database FIG. 3 (300) in the form of datasets 320a, b and c. There can be hundreds or thousands of datasets 320 contained in each database 300. A dataset 320 is a collection of related data presented in tabular form. There are columns in the datasets 320 representing particular variables such as charges, payments, write-offs, and months. Each row in the tabular form 320 and 324 corresponds to a given member of the dataset 320a, b and c. In FIG. 3 the database 300 has three existing datasets 320a, 320b and 320c. Each dataset holds a specific type of data and the columns may differ from one dataset to the next. For example, dataset 1 (320a) holds medical billing data represented by 322, while dataset 2 (320b) includes payroll information as represented by 324. This setup allows the module 500 to be flexible and able to accept and analyze data of different types. An empty dataset 320 has to be created by a client before the module FIG. 3 (500) can import a new type of data. This function is done through the database component 510 of the module FIG. 3 (500). The module FIG. 3 (500) accepts data in text files. An authorized user logs onto the module 500 to initiate the data import. The first step is to specify the source file's location of the data files. The module FIG. 3 (500) then reads the data file and performs an integrity check prior to loading the data. This integrity check ensures that the value in each row is valid and matches the columns of the target dataset 320. An authorized user is also given the option of either appending the new data or overriding the existing data in the dataset 320.

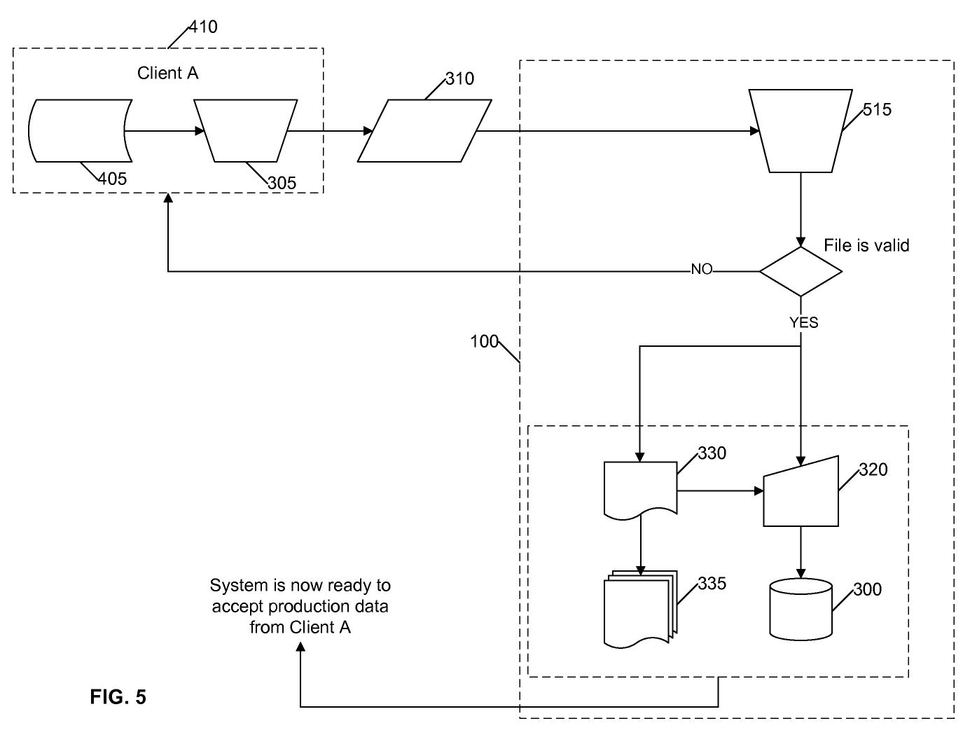

FIG. 5 is a flow diagram illustrating an example of how a new dataset is created in the system 100. In a preferred embodiment a client 410 who has a billing system 405 extracts the data they want to have analyzed by the system. This extracted data 305 are then saved in a flat file data extract 310 so that it may be sent to the system to be analyzed. Once the data extract 310 reaches the system it is analyzed for format and data elements at 515. If the data extract 310 is valid it continues on through the system, if the data extract 515 is not valid it is sent back to the client with a request that the client upgrades the data or provides an alternate file. If the data extract 310 is valid, a parse module 330 is created for the client and the data is processed into a dataset 320. The dataset 320 is created based on the client's requirement parameters as provided as well as on the available data elements. Once the dataset 320 is created the database 300 is updated with this information. If a parse module 330 is created the new module is then added to the system into a collection of parse modules 335 for various clients. Once the dataset 320 and/or the parse modules have been stored the system is ready to accept production of data from the client or to run reports for the client.

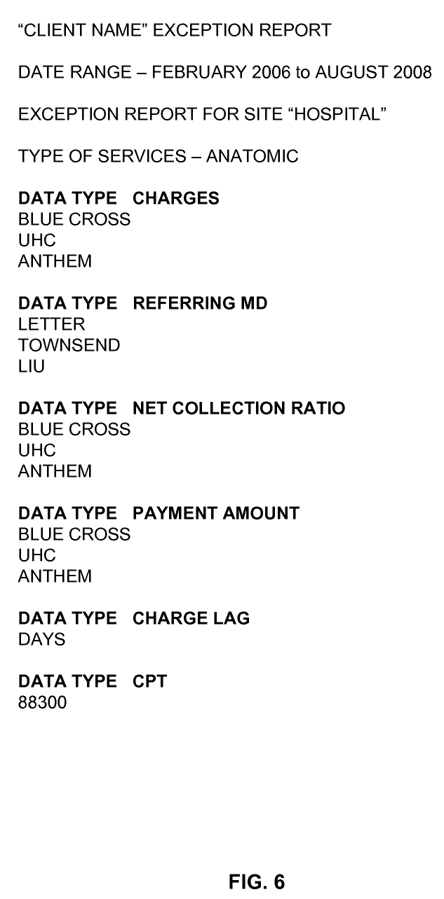

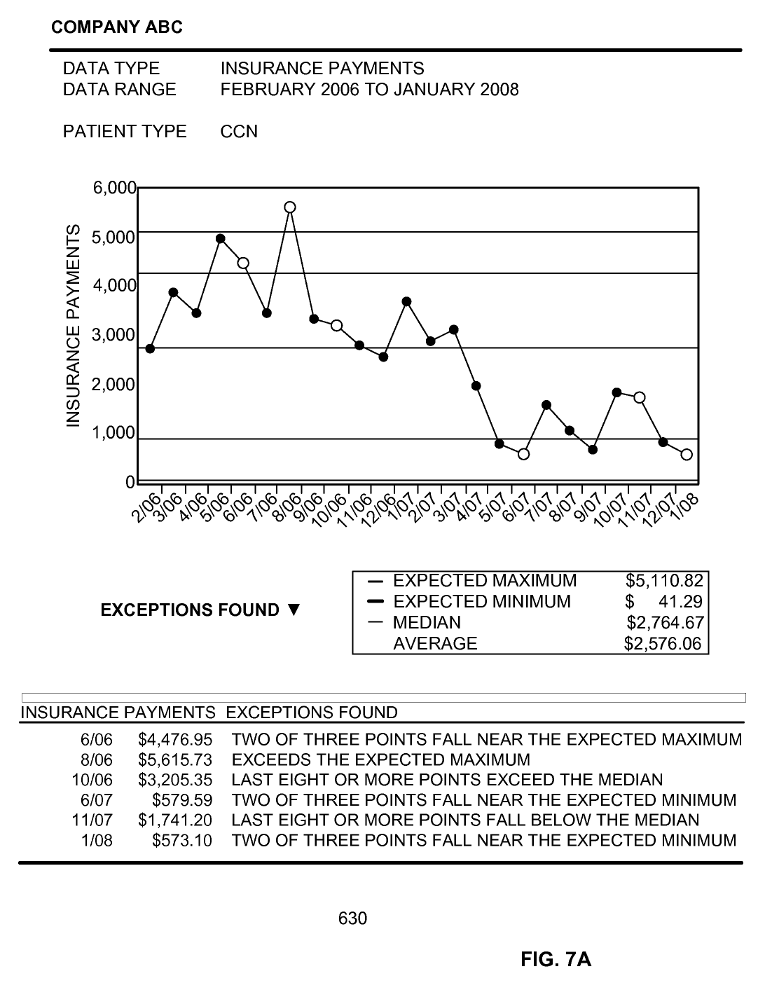

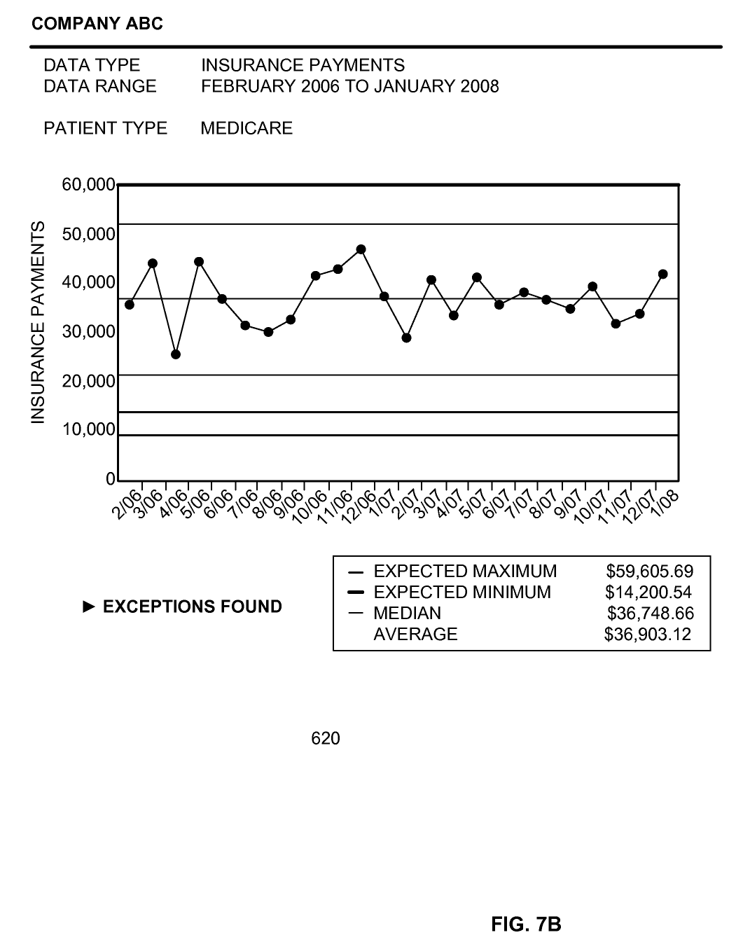

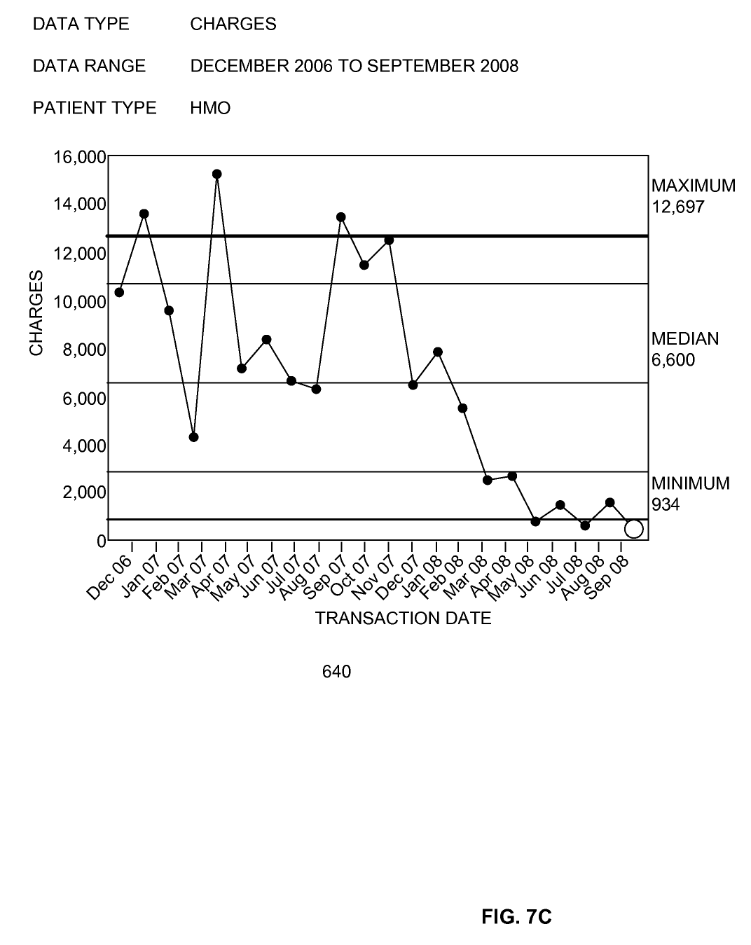

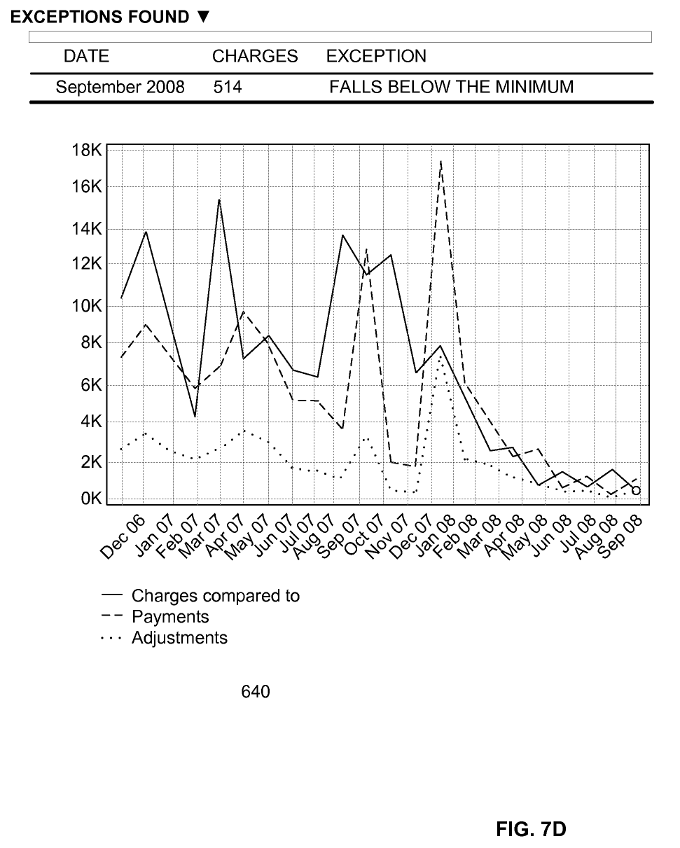

FIG. 6 is an example of a content table within a client exception report showing the list of statistical exceptions for various data element types for various sites of servicel. Sites of service can include, but are not limited to, hospital, lab, outpatient, practice, surgery center and office. Exceptions are hyperlinked to control charts, examples of which are shown in FIG. 7. Pages with control charts have hyperlinks back to the list of exceptions. Once all of the data are collected, the module 500 utilizes its reporting component 520 to collect the data from the database 300 as explained in FIG. 3. The reporting component then can generate client reports including content tables such as the one shown here in FIG. 6. The reports can present all the data reviewed and can display charts both with and without exceptions should the client want to view these items.

Exception charts as shown in FIG. 7 are included in the report. Charts can be in the form of bar charts, control charts, run charts, tables and graphs which show the statistical exceptions. The reporting component 520 of the database 500 utilizes various scientifically validated statistical rules to identify exceptions or variations in the data it is analyzing. A few of these are the following: a 3-standard deviation limit, a 2-standard limit, variation between consecutive points, trends and run lengths. The 3-standard deviation limit analysis runs an exception report if a data point falls above the upper control limit (+3 sigma) or below the lower control limit (−3 sigma). The upper control limit is calculated by multiplying 3.14 to the median moving range of the data points and adding this quantity to the average of the data points. The lower control limit is obtained by subtracting this quantity from the average of the data points. The 2-standard deviation limit analysis runs an exception report if two out of three consecutive points fall between the +2 sigma and upper control limit or between −2 sigma and the lower control limit. In the variance between two consecutive points, an exception will be reported if the difference between those two consecutive data points exceeds the maximum median of the data points moving range (MRMax). The MRMax is calculated by multiplying 3.865 to the median of the moving ranges as calculated from the data in their naturally occurring time order. In the trend analysis an exception will be reported when seven consecutive points are all in either ascending or descending order. A chart can be generated showing all the points. In the run length an exception will be reported if a sequence of eight or more points falls in the same side of the median. Again, a chart can be generated as shown in FIG. 6 to show the run length.

FIG. 7 shows three example control charts generated by the system 100 of the variation in the clients billing system. Chart 620 (Medicare) demonstrates no statistically significant exceptions and is running within the limits. The analysis for these data has been run for the period of time from February 2006 to January 2008. The chart displays the payments by month for the client's particular patient type. The chart displays the expected maximum and expected minimum payment as well as the median average. Charts 630 and 640 have exceptions identified in the dataset. Exceptions are found by running statistical analysis on the datasets in the system 100. Furthermore, FIG. 640 shows a lower chart which graphs payment and adjustments in relation to the charge exception which has been identified above.

Those of skill in the art will appreciate that the various illustrative functions, modules and method steps described in connection with the above described figures and the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules and method steps described in connection with the embodiments disclosed herein can be implemented or performed with a general purpose computer such as a server.

Additionally, the steps of a method or algorithm described in connection with the embodiments disclosed herein can be embodied directly in hardware, in a software module executed by a processor, or in a combination of the two. For example, the steps of a method or algorithm described with the embodiments may be stored as a single module or multiple modules on one or more computer readable media or the computer readable media can be comprised of multiple storage elements or systems. A software module can reside in RAM memory, flash memory, ROM memory, EPROM memory, EEPROM memory, registers, hard disk, a removable disk, a CD-ROM, or any other form of computer readable storage media including a network storage medium. An exemplary storage medium can be coupled to the processor of the computer such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. For example, while the invention has been described generally for use with a billing system, an overall larger payment process may be used. In such embodiments, data from the billing system as well as other data typically used in a payment process, but not necessarily part of the billing system, may be used. Such data may include, for example, tracking payments made to providers. It is further understood that the scope of the present invention fully encompasses other embodiments that may become obvious to those skilled in the art and that the scope of the present invention is accordingly limited by nothing other than the appended claims.

What is claimed is:

1. A computer program, stored in a tangible storage medium, for analyzing billing data, the program comprising executable instructions that cause a computer to:
receive dataset target requirements from a user;
receive a dataset comprising billing data from a user;
format the dataset in accordance with the dataset target requirements to produce a formatted dataset;
identify statistical exceptions from the formatted dataset; and
report the statistical exceptions to the user.

2. The computer program of claim 1, wherein the dataset requirements are selected from the group consisting of purging old data, combining new data with old data, and adding new data fields, and combinations thereof.

3. The computer program of claim 1, wherein the dataset comprising billing data is selected from the group consisting of modality, provider and practice identification numbers, site/service location name, point of service, insurance type, patient type, attending doctor name, referring doctor name, date of service, procedural codes (CPT), quantity (CPT count), charge amount, payment amount, adjustment amount, write-off amount and description, charge entry date, payment entry date, adjustment entry date, write-off entry date, time, counts, errors, first-pass pay rate, denial rate, percent of accounts receivable beyond 60, 90 and 120 days, net collection ratio, gross collection ratio, average charges and payments, and relative value units (RVU), and combinations thereof.

4. The computer program of claim 1, wherein the executable instructions further cause a computer to:
examine the received dataset to ensure that the received dataset meets the received dataset target requirements.

5. The computer program of claim 1, wherein the received dataset is in the form of a text file, a flat file extract, or a tab delimited file.

6. The computer program of claim 1, wherein the executable instructions further cause a computer to:
store the formatted dataset.

7. The computer program of claim 1, wherein the statistical exceptions are identified utilizing tools from the group consisting of a 3-standard deviation limit, a 2-standard limit, variation between consecutive points, trends, run lengths and combinations thereof.

8. The computer program of claim 1, wherein the statistical exceptions are reported to the user in a diagram selected from the group consisting of a bar chart, control chart, run chart, table, graph, and combinations thereof.

9. The computer program of claim 1, wherein the executable instructions further cause a computer to:
report the data in the formatted dataset to the user.

10. The computer program of claim 1, wherein the statistical exceptions are reported to the user on a secured, regular basis or on demand through requests.

11. A computer-implemented method of analyzing billing data, the method comprising:
receiving dataset target requirements from a user;
receiving a dataset comprising billing data from a user;
formatting the dataset in accordance with the dataset target requirements to produce a formatted dataset;
identifying statistical exceptions from the formatted dataset; and
reporting the statistical exceptions to the user,
wherein the formatting the dataset is performed by at least one module residing in a processor.

12. The method of claim 11, wherein the dataset requirements are selected from the group consisting of purging old data, combining new data with old data, and adding new data fields, and combinations thereof.

13. The method of claim 11, wherein the dataset comprising billing data is selected from the group consisting of modality, provider and practice identification numbers, site/service location name, point of service, insurance type, patient type, attending doctor name, referring doctor name, date of service, procedural codes (CPT), quantity (CPT count), charge amount, payment amount, adjustment amount, write-off amount and description, charge entry date, payment entry date, adjustment entry date, write-off entry date, time, counts, errors, first-pass pay rate, denial rate, percent of accounts receivable beyond 60, 90 and 120 days, net collection ratio, gross collection ratio, average charges and payments, and relative value units (RVU), and combinations thereof.

14. The method of claim 11, further comprising:
examining the received dataset to ensure that the received dataset meets the received dataset target requirements.

15. The method of claim 11, wherein the received dataset is in the form of a text file, a flat file extract, or a tab delimited file.

16. The method of claim 11, further comprising:
storing the formatted dataset.

17. The method of claim 11, wherein the statistical exceptions are identified utilizing tools from the group consisting of a 3-standard deviation limit, a 2-standard limit, variation between consecutive points, trends, run lengths and combinations thereof.

18. The method of claim 11, wherein the statistical exceptions are reported to the user in a diagram selected from the group consisting of a bar chart, control chart, run chart, table, graph, and combinations thereof.

19. The method of claim 11, further comprising:
reporting the data in the formatted dataset to the user.

20. The method of claim 11, wherein the statistical exceptions are reported to the user on a secured, regular basis or on demand through requests.
